(19) United States
(12) Patent Application Publication
(10) Pub. No.: US 2005/0181732 A1
(43) Pub. Date: Aug. 18, 2005

(54) Method and apparatus for determining at least an indication of return loss of an antenna

(76) Inventors: Joseph H. Kang, Belle Mead, NJ (US); David J. Wedge, Bristol (GB)

Correspondence Address: HARNESS, DICKEY & PIERCE, P.L.C., P.O. Box 8910, Reston, VA, 20195, US

(21) Appl. No.: 10/779,667

(22) Filed: Feb. 18, 2004

(51) Int. Cl. H04B 7/10

(52) U.S. Cl. 455/67.11

(57) ABSTRACT

A tone generator generates a test signal that a coupler injects into a cable towards an antenna. A receiver or other communication equipment, connected to the antenna via the cable, measures, across a frequency band, at least powers of a signal received at a base station from the antenna. The received signal includes a leakage signal and a reflected signal where the reflected signal is a reflected portion of the test signal and the leakage signal is a portion of the test signal leaking from the coupler away from the antenna. The communication equipment determines maximum and minimum powers of the received signal based on the measurements, and determines at least an indication of return loss of the antenna based on the determined maximum and minimum powers.

### BACKGROUND OF THE INVENTION

1. Field of the Invention

The present invention relates to measuring return loss of an antenna such as in a wireless communication system.

2. Description of Related Art

In communication equipment such as mobile communication base station equipment it is desirable to have a means of determining if an antenna is connected satisfactorily to the equipment. Typically the communication equipment is connected to an antenna by a cable. Incorrect installation, storm damage or aging effects can all lead to an inadequate connection.

An antenna return loss, or ‘VSWR’ (Voltage Standing Wave Ratio) measurement is a common method of determining the quality of the antenna connection. In such a measurement, a radio frequency (RF) tone is coupled into the cable in the direction of the antenna. An RF power detector, within, for example, a receiver of the communication equipment connected to the antenna, determines how much of this tone is reflected back into the equipment and by inference how much has been radiated properly by the antenna. In the event that much of the signal has been reflected, the antenna connection is bad. In the event that little of the signal is reflected, the connection is good.

This conventional antenna VSWR test suffers from errors introduced by cable loss. The reflected signal to be detected is at a somewhat lower power level than the original test tone generated by the communication equipment. This is because the tone has to traverse the length of the antenna cable. For example in a wireless communication system, the tone typically travels from the base station at the bottom of an antenna mast to the antenna at the top of the antenna mast and then back again due to reflection. Tower top equipment such as a tower top duplexer and LNA can also increase this loss.

The wanted reflected signal to be measured interacts with an unwanted signal, which passes directly to the RF power detector from the tone generator within the base station equipment. This error path results from unwanted breakthrough on the directional coupler used to couple the test tone in the direction of the antenna. The unwanted path leaks this signal directly in the other direction, towards the RF power detector.

Interference of the returned signal to be measured with unwanted breakthrough on the directional coupler introduces an error band into the measurement, limiting its accuracy. The interaction of the two signals causes the measured power to exhibit an interference pattern in the frequency domain, which may result in either a greater or lesser indication of return loss than actually exists. As a result, the soundness of the antenna connection may be incorrectly judged When a poor connection is determined, the antenna connection is inspected, further tested, and if necessary fixed. This servicing of the antenna connection may also require shutting down the communication equipment. When the communication equipment is a base station, for example, shutting down the communication equipment results in a loss of call servicing and thus revenue—not to mention the cost of the servicing. When poor connections are incorrectly determined because of the inaccuracy in measuring an indication of return loss, needless servicing and loss of revenue may occur. In addition, the connection may in fact be poor, but the soundness of the antenna connection may be incorrectly determined to be sufficient. In such cases, equipment degradation and perhaps even failure can cause degradation in the quality of service and may also lead to additional costs and loss of revenue.

### SUMMARY OF THE INVENTION

The present invention provides a more accurate method and apparatus for determining at least an indication of antenna return loss. As a result, needless servicing and thus loss of revenue may be prevented, and proper servicing takes place when needed.

In one exemplary embodiment, at least powers of a signal received at communication equipment are measured. The received signal includes a leakage signal and a reflected signal where the reflected signal is a reflected portion of a test signal injected into a coupler towards an antenna connected to the communication equipment and the leakage signal is a portion of the test signal leaking from the coupler away from the antenna and to the communication equipment. Maximum and minimum powers of the received signal are determined based on the measurements, and at least an indication of the return loss of the antenna is determined based on the determined maximum and minimum powers.

In one embodiment, whether the antenna is satisfactorily connected to the communication equipment is judged based on the determined indication of the return loss.

As will be explained in detail below, when the cable connecting the communication equipment to the antenna is of sufficient length, the maximum and minimum powers will generally be acquired through the measurements made on the received signal. However, for short cables, these measurements may not indicate one or both of the maximum and minimum powers. In another embodiment of the present invention, at least one of the maximum and minimum powers are estimated using the measurements. Here, a waveform approximating the received signal is estimated from the measurements, and estimates for at least one of the maximum and minimum powers are determined using the estimated waveform.

### BRIEF DESCRIPTION OF THE DRAWINGS

The present invention will become more fully understood from the detailed description given herein below and the accompanying drawings, wherein like elements are represented by like reference numerals, which are given by way of illustration only and thus are not limiting of the present invention and wherein:

FIG. 1 illustrates a base station connected to an antenna in which the embodiments of the present invention may be implemented.

### DETAILED DESCRIPTION OF EMBODIMENTS

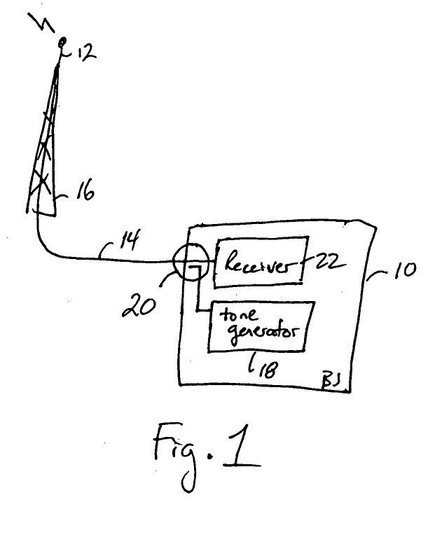

FIG. 1 illustrates an example of communication equipment that may employ one or more of the embodiments of the present invention. Specifically, FIG. 1 illustrates the example of a base station connected to an antenna. As shown, a base station 10 is connected to an antenna 12 by a cable 14. The base station 10 is disposed at the bottom of an antenna mast 16 supporting the antenna 12. However, it will be understood that the base station 10 may be tower mounted, and thus disposed closer to the antenna 12.

The base station 10 includes a tone generator 18. The tone generator 18 generates, for example, a carrier wave or continuous wave (CW) tone. This test signal is coupled in the forward direction of the cable 14 towards the antenna 12 by a directional coupler 20. A receiver 22 of the base station 10 includes, among other things, an RF power detector (e.g., a received signal strength (RSSI) detector) for detecting the amount of power of the test signal reflected back to the receiver 22 from the antenna 12.

This reflected signal is subject to a delay T1 through the cable 14 and back. It is also subject to an attenuation k, which depends on the insertion loss of the cable 14 and the wanted part of the information—the return loss of the antenna 12. Breakthrough of the test signal from the coupler 20 (hereinafter “the leakage signal”) also passes directly to the receiver 22; the delay of the leakage signal is negligible and is expressed below in expression (6) with no delay. Hence, when testing for the return loss of the antenna 12 by injecting the test signal into the coupler 20 in the direction of the antenna 12, the signal received at the receiver 22 is the sum of the reflected signal and the leakage signal, and may be expressed as:
f(t)=cos(w_{c}t)+k·cos(w_{c}[t−T₁]+φ) (1)
where cos(w_{c}t) represents the leakage signal and kcos(w_{c}[t−T₁]+φ) represents the reflected signal.

Or this can be considered as a CW signal that passes through a channel with the following impulse response:
h(t)=∂(t)+k∂(t−T₁) (2)

In the frequency domain this appears as a ‘sinusoidal’ signal with magnitude vs. frequency:
|H(f)|=2+2kcos(2πT₁f) (3)

In a first exemplary embodiment of the present invention, a full excursion of the sinusoidal signal between one maximum amplitude and one minimum amplitude provides for making an accurate measurement. However, another embodiment of the present invention, described in detail below, provides an accurate measurement even when a full excursion is unavailable.

The period of the sinusoid in frequency depends on the length of the cable 14. The longer the cable 14 is, the greater the time delay and the more excursions there are within the same frequency span. A cable with length 40 meters will contain at least 1 maximum amplitude and 1 minimum amplitude in the 3.84 MHz receiver bandwidth. For longer runs there will be more. For shorter cable runs, the receiver 22 may be re-tuned to pick them out, and/or, the other embodiment of the present invention may be adopted.

The tone generator 18 generates a test signal that makes a frequency sweep across a desired bandwidth (e.g., the bandwidth of a channel of the receiver 22). The magnitude (difference between the maximum point and minimum point) of the sinusoid in frequency is determined by making RSSI measurements in the usual way at the receiver 22. From the maximum and minimum power in the frequency domain measurements the power in the reflected signal from the antenna and the power in the leakage signal may be independently determined as described in detail below.

The expression below provides for converting between frequency domain peak excursions and powers in the reflected and leakage signals:
h(t)=Vₗ·∂(t)+V_{w}·∂(t−T₁)
h(jw)=Vₗ+V_{w}·exp(−T₁·jw)
h(jw)=Vₗ+V_{w}·cos(−T₁·w)+jV_{w}·sin(−T₁·w)
|h(w)|²=[Vₗ+V_{w}·cos(−T₁·w)]²+V_{w}²·sin²(−T₁·w)
|h(w)|²=Vₗ²+V_{w}²+2·Vₗ·V_{w}·cos(−T₁·w) (4)
where Vₗ and V_{w} represent the amplitude (e.g., voltage) of the leakage and reflected signals, respectively. When the power in the frequency domain is at its maximum then this expression simplifies to:
|h(f)|²=Vₗ²+V_{w}²+2·Vₗ·V_{w} [symbol] (Vₗ+V_{w})² (5)

When the power in the frequency domain is at its minimum then this expression simplifies to:
|h(f)|²=Vₗ²+V_{w}²−2·Vₗ·V_{w} [symbol] (Vₗ−V_{w})² (6)
Hence the power in the received signal (i.e., the combined reflected and leakage signals) and the maximum and minimum powers in the frequency domain are related by the following:
|H(f)|ₘₐₓ=Vₗ+V_{w} |H(f)|ₘᵢₙ=|Vₗ−V_{w}| (7)

These can be re-expressed to calculate the amplitude of each signal from knowledge of the maximum and minimum power in the frequency domain:

$$\begin{matrix}Leakage \text{:} {V}_{l} = \frac{{\vert H ( f ) \vert}_{max} + {\vert H ( f ) \vert}_{mix}}{2} & ( 8 ) \\ Reflected \text{:} {V}_{w} = \frac{{\vert H ( f ) \vert}_{max} + {\vert H ( f ) \vert}_{mix}}{2} & ( 9 )\end{matrix}$$

Equations (8) and (9) provide the amplitudes for the leakage and reflected signals when the leakage amplitude is greater than the reflected amplitude. However, when the reflected amplitude is greater than the leakage amplitude, equation (8) provides the reflected amplitude and equation (9) provides the leakage amplitude. The determination of which amplitude is represented by equations (8) and (9) in several ways. Because the directional coupler 20 is designed to meet certain leakage specifications, the leakage amplitude may be assumed to closely follow the specification. As such, the result of equations (8) and (9) closest to the leakage specifications of the directional coupler 20 is assumed to be the leakage amplitude. Alternatively, under known antenna connection conditions, a test signal may be applied via the tone generator to obtain the leakage signal. Afterwards, the leakage signal is considered to remain substantially constant, while the reflected signal will vary over time. Accordingly, the more time-invariant signal is treated as the leakage signal during operation.

As will be appreciated from the above disclosure, the receiver 22 determines at least an indication of the return loss from the maximum and minimum power level measurements made during the frequency sweep described above. Next, this return loss determination will be described in detail under the assumption that the leakage amplitude is greater than the reflected amplitude; however, the alternative operation where the reflected amplitude is greater will be readily apparent from this description.

Assume, minPinFdBm represents the minimum power level detected in dB in the frequency sweep and maxPinFdBm represents the maximum power level detected in dB in the frequency sweep. Then, the receiver 22 converts these frequency domain power measurements in dB to Watts according to:
minPinFW=10.\hat{ }((minPinFdBm−30)/10) (10)
maxPinFW=10.\hat{ }((maxPinFdBm−30)/10) (11)
where minPinFW and maxPinFW represent the minimum and maximum frequency domain power levels, respectively, converted to Watts. Then, the receiver 22 converts these the minimum and maximum power levels in Watts to minimum and maximum average voltages according to:
minVavinF=sqrt(2*Ro.*minPinFW) (12)
maxVavinF=sqrt(2*Ro.*maxPinFW) (13)
where Ro represents the impedance of the cable 14 and minVavinF and maxVavinF represent the minimum and maximum average voltages, respectively.

Then, the receiver 22 determines the average voltage or amplitudes of the leakage and reflected signals as follows:
Vl=(maxVavinF+minVavinF)/2 (14)
Vw=(maxVavinF−minVavinF)/2 (15)
Subsequently, these average voltages are converted to Watts according to:
PlW=(Vl.\hat{ }2)/(2*Ro) (16)
PwW=(Vw.\hat{ }2)/(2*Ro) (17)
And, the powers of the leakage signal and reflected signal in dBm in the time domain are determined according to:
PldBm=10.*log10(PlW)+30 (18)
PwdBm=10.*log10(PwW)+30 (19)
where PldBm and PwdBm represent the power of the leakage signal and reflected signal, respectively, in dBm in the time domain. The power PwdBm of the reflected signal is directly proportional to the return loss. Accordingly, the receiver 22 may compare this to a threshold power. If the power of the reflected signal is greater than the threshold power, the receiver 22 determines that a poor connection exists. A calibration of the antenna damage threshold power may be achieved by assuming the antenna 12 to be good at the time of base station installation and setting a threshold at some appropriate level based on empirical data, typically 5 dB above the signal power measured at the receiver 22 at that time.

Alternatively, the numerical return loss of the antenna connector may be calculated by finding the difference in power between the signal at the receiver 22 and the signal at the tone generator 18, and then subtracting the attenuation resulting from the other elements in the test signal's path. These are the directional coupler 20 and the cable loss 14, which must be counted twice as the signal traverses its length to the antenna connector and is reflected along the same cable back toward the receiver 22. If the return loss is greater than a threshold return loss, then a poor antenna connection is determined. The wanted reflected signal power PwdBm found by application of the above described method is used in this calculation of return loss as the power resulting at the receiver 22. As a result, the power resulting at the receiver 22 used in the calculation of return loss is not subject to the error caused by the interference pattern in the frequency domain resulting from the interaction of the reflected signal with the leakage signal.

When a poor connection is determined, the base station 10 may then issue an alarm that servicing is required. This alarm may be a visual alarm at the base station 10, or a warning message communicated to, for example, a mobile switch center. The threshold return loss or threshold power are design parameters set by the system designer based on empirical study.

The above described embodiment produces an accurate indication of return loss when at least one full excursion of the sinusoidal test signal reflects back to the receiver. As further discussed above, whether this condition holds depends in large part on the length of the cable 14. For example, for tower mounted base stations 10, the length of the cable 14 may insufficient for one full excursion to appear. Next, an embodiment for determining an indication of return loss or a poor connection accurately when one full excursion is not available will be described.

The received signal resulting from the frequency sweep of the test signal may be modeled as:
yᵢ=A+Bcos(Cwᵢ+D)+nᵢ for i=1, . . . , N (20)
where yᵢ represents the samples of the received signal, A represents a DC component of the received signal, C is a function of the periodicity of the received signal and will be referred to herein as “the periodicity C”, wᵢ is the frequency of the frequency sweep when sampled, D represents a shift in the frequency, nᵢ represents the noise when sampled, and i represents the measurement samples of the received signal.

The received signal may alternatively be defined as:
yᵢ=A+Fcos(Cwᵢ)+Gsin(Cwᵢ)+nᵢ (21)
where B=sqrt(F²+G²) and D=tan⁻¹(−F/G). Next, for the set of measurement i=1, . . . , N, the received signal may be expressed as a vector y according to the following expression:
y=Ex (22)
where y represents the measurement vector with length N; E is an N×3 matrix with each row containing [1 cos(Cwᵢ) sin(Cwᵢ)] for i=1, . . . , N; and x=[A F G]^{T}.

As shown above, E is dependent on the periodicity C of the received signal. Accordingly, determining C permits a determination of E because the remaining variables are known. Once E is determined, a solution for x may be obtained from the determined value of E and the known values of y. This then provides a complete model of the received signal from which the maximum and minimum power measurements may be predicted, and thus the return loss determined. Accordingly, a description of how to determine C will now be described.

The periodicity C is estimated using a least squares computation shown below:
Y^{T}E(E^{T}E)⁻¹E^{T}y (23)
Namely, expression (23) is applied to a set of possible values for C. The value of C from the set of possible values that produces the maximum value when expression (23) is applied is selected as the estimated value of C.

As discussed above, the periodicity C is estimated using a single set of N measurements of the received signal. The estimation of the periodicity C may be further improved by obtaining K sets of N measurements of the received signal, and deriving an estimate of C for each of the K sets. Then, clustering techniques such as the well known statistical technique of K means clustering may be applied to the K estimates of C, to eliminate outliers. The final estimated value of C may then be estimated using the pruned set with a relatively high confidence (e.g., 90% or greater).

Having determined the estimated value of C, the matrix E may be determined as described above. Then, using expression (22) the value of x may be determined from the known values of E and y. Determining x provides values for A, F and G in expression (21), and as described above, the values of B and D in expression (20) may be determined from the values of F and G. Accordingly, a model of the received signal according to either expression (20) or expression (21) is determined. This model may then be used to determine the maximum and minimum power of the received signal. Then, the indication of return loss and quality of the connection to the antenna may be determined in the same manner described above in detail with respect to the first embodiment.

As will be appreciated from the above discussion, the periodicity C may be known, determined through testing under controlled conditions, or determined according to any other well-known method.

The embodiments of the present invention provide for an accurate indication of return loss from an antenna. Using this determination, the quality of the connection between communication equipment and an antenna may be determined with reduced error. This helps eliminate incorrectly determining that a poor connection to the antenna exists, and reduces unnecessary service calls to address possible poor connections. As a result, the down time experienced by the communication equipment as a result of incorrect determinations of poor connection is greatly reduced, and revenue increases.

The invention being thus described, it will be obvious that the same may be varied in many ways. For example, while the present invention was described above using the example of a base station as the communication equipment, the present invention is not limited to being employed by base stations. Such variations are not to be regarded as a departure from the spirit and scope of the invention, and all such modifications as would be obvious to one skilled in the art are intended to be included within the scope of the invention.

1. A method of determining an indication of return loss of an antenna of a wireless communication system, comprising:
measuring, across a frequency band, at least powers of a signal received at communication equipment from an antenna connected to the communication equipment, the received signal including a leakage signal and a reflected signal, the reflected signal being a reflected portion of a test signal injected into a coupler towards the antenna, and the leakage signal being a portion of the test signal leaking from the coupler away from the antenna to the communication equipment;
first determining maximum and minimum powers of the received signal based on output of the measuring step; and
second determining at least an indication of return loss of the antenna based on the determined maximum and minimum powers.

2. The method of claim 1, wherein the measuring step samples the received signal at a fixed interval in at least measuring the power.

3. The method of claim 1, wherein
the measuring step measures the powers of the received signal in the frequency domain; and
the second determining step determines an average voltage of the reflected signal based on the determined maximum and minimum powers of the received signal, and determines an indication of the return loss from the determined average voltage of the reflected signal.

4. The method of claim 3, wherein the second determining step converts the determined average voltage of the reflected signal to a time domain power of the reflected signal, and determines an indication of the return loss from the determined time domain power of the reflected signal.

5. The method of claim 4, further comprising:
judging whether the antenna is satisfactorily connected to the base station when the time domain power of the reflected signal exceeds a threshold power.

6. The method of claim 4, wherein the second determining step converts the time domain power of the reflected signal into a return loss of the antenna.

7. The method of claim 6, further comprising:
judging whether the antenna is satisfactorily connected to the base station when the determined return loss exceeds a threshold value.

8. The method of claim 1, wherein the first determining step estimates at least one of the maximum and minimum powers using the output of the measuring step.

9. The method of claim 8, wherein the first determining step estimates a waveform approximating the received signal based on the output of the measuring step, and estimates at least one of the maximum and minimum powers using the estimated waveform.

10. The method of claim 9, wherein the first determining step estimates a value representing periodicity of the received signal using the output of the measuring step, and estimates the waveform using the estimated value.

11. The method of claim 1, further comprising:
judging whether the antenna is satisfactorily connected to the base station based on the determined indication of return loss.

12. The method of claim 11, further comprising:
issuing an alarm when the judging step judges that the antenna is not satisfactorily connected to the base station.

13. An apparatus for determining an indication of return loss of an antenna of a wireless communication system, comprising:
a tone generator generating a test signal;
a coupler injecting the test signal into a conductor towards the antenna; and
communication equipment, connected to the antenna via the conductor, measuring, across a frequency band, at least powers of a signal received at a base station from the antenna, the received signal including a leakage signal and a reflected signal, the reflected signal being a reflected portion of the test signal and the leakage signal being a portion of the test signal leaking from the coupler away from the antenna to the communication equipment; determining maximum and minimum powers of the received signal based on output of the measuring; and determining at least an indication of return loss of the antenna based on the determined maximum and minimum powers.

14. The apparatus of claim 13, wherein the communication equipment is a receiver of a base station.
